(19) United States
(12) Patent Application Publication
(10) Pub. No.: US 2006/0224798 A1
(43) Pub. Date: Oct. 5, 2006

(54) Personal music preference determination based on listening behavior

(76) Inventors: Mark D. Klein, Los Altos, CA (US); Tom Zito, Sausalito, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/359,903

(22) Filed: Feb. 21, 2006

Related U.S. Application Data
(63) Continuation-in-part of application No. 11/216,543, filed on Aug. 30, 2005.
(60) Provisional application No. 60/655,305, filed on Feb. 22, 2005.
(60) Provisional application No. 60/683,228, filed on May 20, 2005.

(51) Int. Cl. G06F 13/38

(52) U.S. Cl. 710/62

(57) ABSTRACT

Music preferences for users are determined by direct sampling and analysis of the user's listening behavior. A user's preferences are derived by identifying songs listened to by the user and analyzing the user's switching-behavior among songs actually being played on the air.

### CROSS-REFERENCE TO RELATED APPLICATIONS

This application claims priority from U.S. Provisional Application No. 60/655,305, titled “PERSONAL MUSIC PREFERENCE DETERMINATION BASED ON LISTENING BEHAVIOR,” filed Feb. 22, 2005 (attorney docket number 10056), the disclosure of which is incorporated herein by reference.

This application further claims priority from U.S. Provisional Application No. 60/683,228, titled “DETECTING AND TRACKING ADVERTISEMENTS,” filed May 20, 2005 (attorney docket number 10422), the disclosure of which is incorporated herein by reference.

This application further claims priority as a continuation-in-part of U.S. Utility application Ser. No. 11/216,543, titled “DETECTING AND MEASURING EXPOSURE TO MEDIA CONTENT ITEMS”, filed Aug. 30, 2005 (attorney docket number 10389), the disclosure of which is incorporated herein by reference.

### BACKGROUND

Radio stations want listeners to change the channel as infrequently as possible, because churn among stations negatively impacts a radio station's ratings and, consequently, the amount the station can charge advertisers. Station programmers depend heavily on market research to develop their music playlists, in hopes that they can mitigate consumers' desire to change the channel. One of the most successful market research tools used to do this in the past two decades has been so-called “Callout Research” (CR). In CR, rotating members of a panel of participants who have identified themselves as regular listeners of a station listen to short clips of songs over the phone and register their opinion of each clip. The researchers are endeavoring to figure out which songs have the greatest likelihood of invoking station-changing impulses. CR has become the norm in determining play-lists.

Because of the onslaught of telemarketing calls and consumer adoption of caller ID and do-not-call registries, it has become increasingly difficult to reach people who statistically represent average listeners.

Research methods that employ surveys are inherently inaccurate because stated preferences do not exactly match actual behavioral preferences. In the case of CR, a panel member may register a positive opinion of a music clip when listening to the first 10 seconds. When listening to a broadcast of the song from which the clip was extracted, the same panel member may change stations halfway through the song. Collection and analysis of this actual switching-behavior can lead to more useful market research information.

### SUMMARY

In various embodiments, the present invention provides methods and systems for determining panel member (user) preferences by direct sampling and analysis of the user's listening behavior. A user's preferences are derived by identifying songs listened to by the user and analyzing the user's switching-behavior among songs actually being played on the air.

### BRIEF DESCRIPTION OF THE DRAWINGS

FIG. 1 is a block diagram depicting an architecture for practicing the present invention according to one embodiment.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

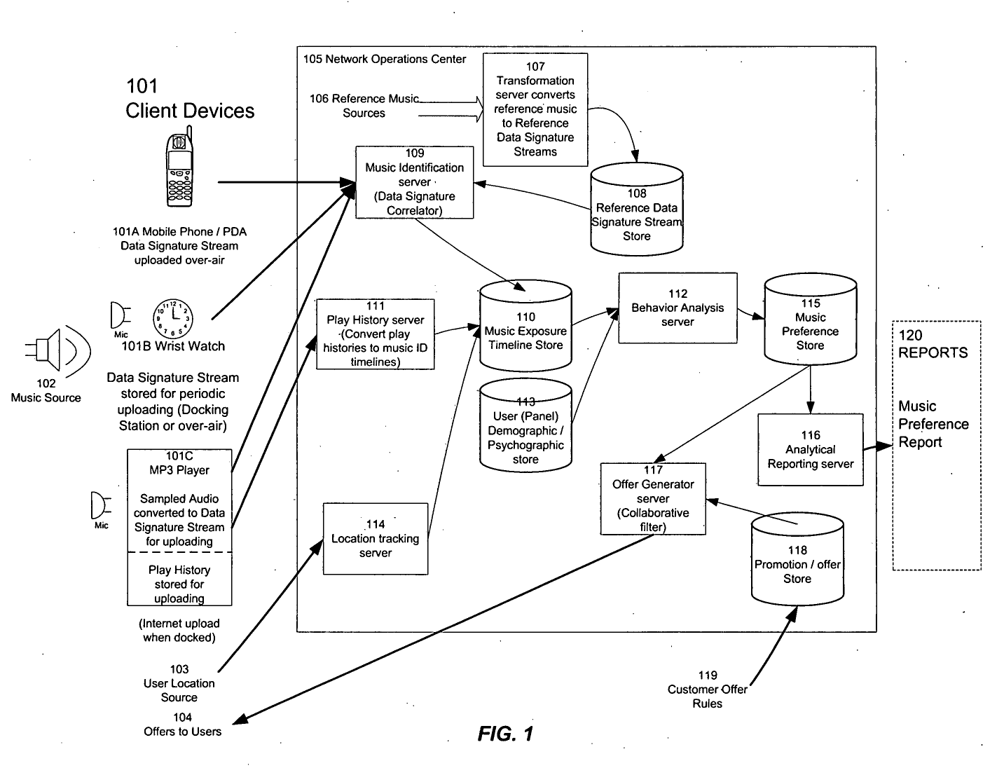

Referring now to FIG. 1, there is shown an embodiment of the invention. According to this embodiment, a personal music preference determination system consists of one or more client devices 101, an upload scheme, a music identification server 109 (and/or a play history server 111), and a behavior analysis server 112. In addition, an offer generator server 117 can be used to make music-related offers 104 directly to the user.

The client device 101 samples audio the user is exposed to. The audio to be sampled can be external to the device 101 or it can be audio the device stores for playback to the user. In the preferred embodiment, the client device is built into a personal mobile device such as a mobile phone 101A, personal digital assistant (not shown), MP-3 player 101C, or wristwatch 101B. Music can come from any source 102.

The upload scheme uses data compression to minimize required bandwidth and reduce costs. The preferred embodiment transforms externally-sampled audio from source 102 into a data signature stream that maintains sufficient frequency-domain, time-domain, (or other transform domain) features to determine what music (or other audio) is being listened to. This data signature stream is transmitted to the Network Operations Center (NOC) 105 for analysis. Audio the device 101 plays to the user (if the device is an MP-3 player 101C, for example), can be characterized by a set of identification numbers or strings and uploaded to the NOC 105 as a music play history list that is sent to play history server 111. The signature stream and play history list information is time stamped by the client device 101. In one embodiment, server 111 converts play histories to music ID timelines for storage at store 110.

The music identification server 109 correlates the data signature stream against a set of stored reference data signature streams 108 (transformed from the set of all songs of interest) to determine which candidate audio source, if any, the user was listening to at any given time. A timeline of music exposure for each user is created and stored at timeline store 110. If music play history list information is available for the user, it is added to the timeline of music exposure at store 110.

The behavior analysis server 112 uses the timeline of music exposure from store 110 to determine a user's preferences. Analysis is performed to determine if the music exposure was deliberate or incidental. User location information, when available from location tracking server 114 and determined from user location source 103, can assist in the behavior analysis. Other user attributes can also be factored into the preference determination. For example, server 112 may use information on users' demographics and psychographics, as obtained from store 113.

According to one embodiment, a behavior analysis algorithm employing a rating tally follows these steps:

1. Factor out incidental music

1.1. If the signal/noise ratio drops below a threshold, the music is deemed incidental

1.2. If music starts playing as the user enters a shopping mall or other public location known to play background music, eliminate the songs played while the user is at that location. (Ambient music in a shopping mall is not related to user preference.)

2. Apply rating points to each remaining song

2.1. Broadcast music sources

2.1.1 Add a high point value to a song the user switched to partway in, listened to until completion, and listened to for at least 30 seconds.

2.1.2 Add a medium point value to a song the user listened to from start to completion.

2.1.3 Subtract points from a song the user switched away from before completion, if the user continued to listen to other music.

2.2. Non-broadcast music sources

2.2.2 Add a high point value to a song the user listened to from start to completion.

2.2.3 Subtract points from a song the user switched away from before completion if the user continues to listen to other music.

The resulting user music preferences are stored at store 115. In one embodiment an analytical reporting server 116 generates panel preference reports 120 this stored information. Using collaborative filtering, or other methods, an offer generator server 117 can generate music preference-related offers 104 for individual users. These offers, which can be generated based on information stored at promotion/offer store 118 and further based on specified offer rules 119, can include offers to sell songs direct to the user through the client device.

One skilled in the art will recognize that the system architecture illustrated in FIG. 1 is merely exemplary, and that the invention may be practiced and implemented using many other architectures and environments.

In one embodiment, the system of the present invention is enhanced with the ability to determine the physical location of a panelist so as to facilitate correlations of ad exposure with visits to a retail location. For example, a retailer might want to know which of various creative executions of its commercial did the best job of driving consumers into its retail locations. Triangulation from cell towers or GPS data can be useful in this regard. In some instances—especially in an indoor shopping mall—these methods may not work. In these instances, it is possible to embed a cell phone within the specific retail location(s) the system wishes to track. Ambient sound from the location—music playing, crowd noise, and the like—is continuously monitored on the phone, which in turn creates an ongoing set of signatures. By comparing the signatures collected from panelist cell phones with the signatures collected from the cell phone(s) placed in retail location(s), the system can positively determine whether, where, when and for what duration a panelist was in a retail location.

In one embodiment, the cell phone or other monitoring device embedded in the retail location operates using different sampling ratios than monitoring devices associated with panelists. For example, if the panelist-based monitoring devices sample audio for ten seconds every thirty seconds, the static monitoring device might perform continuous sampling so as to more accurately establish correlation to the background audio environment. In one embodiment, the continuous sampling stream can be broken up into segments, of for example, five minutes' length. These segments can be fingerprinted and then sent to NOC 105 via a radio Internet connection on the cell phone.

In one embodiment, the present invention is implemented in connection with techniques described in the above-referenced related U.S. patent applications and provisional applications, the disclosures of which are incorporated herein by reference.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magneticoptical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method for determining personal music preference for a user, comprising:
receiving data describing audio to which a user has been exposed;
comparing the received data against reference data to identify the audio;
generating a music exposure timeline;
analyzing to the generated music exposure timeline to determine music preferences for the user; and
generating a report summarizing the determined music preferences.
